(19) United States
(12) Patent Application Publication
(10) Pub. No.: US 2007/0293627 A1
(43) Pub. Date: Dec. 20, 2007

(54) Method for increasing compatibility of recycled materials using supercritical carbon dioxide

(75) Inventors: Mitchell Fourman, Stony Brook, NY (US); John Michael Iraci, Kings Park, NY (US); Miriam Rafailovich, Plainview, NY (US)

Correspondence Address: THE FARRELL LAW FIRM, P.C., 333 EARLE OVINGTON BOULEVARD, SUITE 701, UNIONDALE, NY, 11553, US

(73) Assignee: The Research Foundation of State on New York, Stony Brook, NY (US)

(21) Appl. No.: 11/804,713

(22) Filed: May 18, 2007

Related U.S. Application Data
(60) Provisional application No. 60/801,278, filed on May 18, 2006.

(51) Int. Cl. C08F 290/14

(52) U.S. Cl. 525/50; 528/480; 264/239

(57) ABSTRACT

A method and apparatus are disclosed for producing supercritical carbon dioxide treated blends including steps of blending at least three compatible materials in a melt intercalation to produce a tri-blend, molding the tri-blend into shapes suitable for ASTM, and exposing the tri-blend mixture to CO₂ for a predetermined amount of time so as to produce a supercritical carbon dioxide treated tri-blend material.

### PRIORITY

This application claims priority to application Ser. No. 60/801,278 filed with the U.S. Patent and Trademark Office on May 18, 2006.

### GOVERNMENT SUPPORT

The invention was supported, in part, by the U.S. Government, grant 1011182-011689, NSF-MRSEC. The U.S. Government has certain rights in the invention.

### BACKGROUND OF THE INVENTION

1. Field of the Invention

The present invention relates generally to methods for increasing compatibility of recycled materials using supercritical carbon dioxide.

2. Background of the Related Art

Poly(vinyl chloride) (PVC) products represent one of the most voluminous wastes manufactured in the United States and are part of a total plastics group which produces 6.67 billion tons of solid waste per year (CIEC, 2004). There are 30 million PVC products produced annually. They are the second largest volume thermoplastic waste only to polyethylene (Engelmann, 1997). To reduce the US landfills of PVC, recycling plants bum the plastic to decrease the landfill sizes. However, this process produces noxious gas by-products, such as dioxins, PCB's and other toxins (CIEC, 2004). When recycled by remolding, PVC cannot be rejuvenated back to original strength and form and does not exhibit the same desirable properties.

An ideal plastic has properties of high ductility, tensile strength, and cost effectiveness in numerous applications especially if it is recyclable. Work has been done to discover different ways of recycling PVC waste, such as the chemical processes of cracking, gasification, hydrogenation and pyrolysis (Braun, 2002). Also, there have been smaller projects that have broken down PVC wastes into smaller chemical short chains (Braun, 2002). This chemical method of recycling has presently been introduced in such countries as France, however recycling methods have failed to solve the problem of continued landfill overflow in the US. The amount being recycled is not equal to the amount produced or disposed (CIEC, 2004).

Most polymers are incompatible, therefore they phase segregate when mechanically mixed together. This degrades the mechanical properties of the polymers. Consequently recycled materials, when combined with polymer blends, frequently perform poorly in mechanical tests. Existing methods of compatibilization such as surfactants, block co-polymers are expensive and very specific to binary mixtures. As a result they are not economically practical for use in processing recycled polymers. Supercritical CO₂, on the other hand, is a non-specific universal compatibilizer which can work on binary or multiple number blends. In addition, it is inexpensive and environmentally benign.

To create an ideal plastic, there will be a need to utilize supercritical fluids (SCFs). Due to SCF's unique solvent strength, and since supercritical CO₂ (scCO₂) is a universal compatibalizer for polymers, the blend of these processes produces a superior plastic (Fourman et al., 2002). This is verified through the observation of the swelling and density fluctuations of polymers (Koga, 2001). Also, this is confirmed from the properties changed after blending of the new plastic (Tomasko, 2003).

There are density changes through the polymer because the exposure to CO₂ creates many air bubbles throughout it. The area in between the air pockets has a higher density than the area before exposure. A supercritical fluid is a phase of matter that exhibits viscosity, diffusivity, and density characteristics that are greatly different from its liquid and gaseous phases. FIG. 1 illustrates how these properties change from phase to phase. The supercritical domain is located at a temperature and pressure above its liquid and gaseous phases. FIG. 2 displays a graph of pressure versus temperature for CO₂, showing similar locations of the supercritical domain (Cansell et al., 2003). Also illustrated on the graph is supercritical carbon dioxide's critical pressure of 73 atm and critical temperature of 31.1° C.

Three different polymer blends were prepared and then exposed to scCO₂. The blends were poly (methyl-co-methacrylate-blend-ethylene-co-vinyl acetate-blend-r-poly-vinyl chloride) (PMMA/EVA/rPVC) with various weight ratios of 1:1:1 and 1:2:1 in addition to the PMMA/EVA/rPVC blended with 8% nano-clay composite or a surfactant. Since there are three polymer components in each blend they are referred to as “tri-blends.” The EVA and PMMA components were chosen based on mechanical properties and ease of availability, to optimize with the recycled PVC. The percentages of each polymer in the tri-blend are shown in Table 1 below.

TABLE I

| Tri- | | Reference |
|---|---|---|
| blend | Materials | name |
| 1 | PMMA, EVA, PVC | |
| | 33(⅓)%, 33(⅓)%, 33(⅓)% | 111 |
| 2 | PMMA, EVA, PVC | |
| | 25%, 50%, 25% | 121 |
| 3 | PMMA, EVA, PVC, | |
| | Cloisite 6A | |
| | 23%, 46%, 23%, 8% | Clay blend |

PMMA (FIG. 3) was chosen because of its lightweight and hardness. Examples of PMMA products are Plexiglas, Lucite, and acrylic. EVA is a rubber like polymer which is very ductile and strong with the ability to stretch. EVA (FIG. 4) is a softer material that is ductile, strong and flexible. It is a predominately amorphous polymer with only a small percentage of crystalline morphology. EVA was chosen because it is a known plasticizing agent which can render a polymer blend more ductile (DuPont, 2004).

PVC (FIG. 5) was mainly chosen for its abundance, cheap cost and its potential to be recycled. PVC is used mainly for pipes, profiles, floor coverings, cable insulation, roofing sheets, packaging foils, bottles, and medical products (Braun, 2002). PVC is also a thermoplastic that is rigid and opaque. It is resistant to fire, X-rays, acids, bases, oils, grease, and alcohol (Macro galleria, 2004). The use of recycled PVC can help reduce landfill sizes and emissions of noxious gases when burned (CIEC, 2004). In one of the blends, a clay surfactant (Cloisite 6A) was added before supercritical exposure to help increase compatibility (Si, 2003). However, clay has been noted for its ability to be the weakest link in a polymer blend (Woods, 2004). Sixty samples of plastic (20 of each tri-blend) were formed. The samples were tested for strength, load, glass transition temperatures and modulus change.

The purpose of this project was to create tri-blend plastics, of varying polymer ratios made from recycled PVC. All blends were exposed to scCO₂ to test its effects on modulus, compatibilization and Tg. The Izod Impact Factor and Floury Fox equation were applied to test for the correlation between theoretical and measured results.

In the present invention, materials and methods used include Brabending (twin-arc extruder) (CW Brabender type epl-v501): A physical bulk blend of three polymers (tri-blend) is prepared via twin-screw melt intercalation. The mixing apparatus (“Brabender”) is preheated to 170° C. with a twin-screw speed set to 20 runs per minute (rpm). About half of the weight for each component polymer is initially blended in the extruder for 1 minute. After the 1-minute, the remaining polymers are incorporated into the mix. The speed is then increased to 100 rpm and is run for 15 minutes to ensure proper blending. Next, the rotor speed is slowly decreased to 0 rpm and the temperature relay is turned off. Finally, the blend is removed. The resulting raw material is black or gray in color. It is flexible when hot, but stiff enough at room temperature for fracture cutting with a razor blade.

Molding for ASTM test methods: (Carver hydraulic Heat press model 3912) After all ratios of the tri-blend are mixed, the materials are molded into “dog bone” or rectangular shapes, as shown in FIG. 6, for testing. These shapes are suitable for ASTM (American Standard for Testing Materials) standard tensile testing for mechanical properties. The press is preheated to 330° F. Two solid circular plates, one mold plate and two nonstick Kapton sheets which keep the tri-blend from sticking to solid plates on the heat press, are collected. One solid circular plate is placed down, and a piece of kapton is placed on top. The mold plate is placed on top of this configuration and precut sample pieces are placed in molds. The remaining kapton sheet and solid circular plate are placed on top. The resulting “sandwich like” setup is put into the press and preheated at 330° F. for 5 minutes with no pressure. The pressure is then increased to 4 tons and left for 15 minutes. Finally, it is removed from the press and set on a cooling rod. When cooled, the rectangle or dogbone shaped samples are removed using a razor. Excess samples are removed from the mold.

Bulk SCF C0₂ preparation: First, the CO₂ Chamber is prepped for a run. Preparation consists of submerging the CO₂ chamber in ice water until its internal equilibrium temperature reaches 65° F. Next, the chamber is dried off and placed into the holding cell. All connections —CO₂ input port, internal thermal couple, pressure transducer, and CO₂ release valve—are connected. Band-heaters are attached externally. Before each run the emergency rupture disk is inspected to ensure safety. Samples are then placed into the chamber. An O-ring is inserted with a vacuum cup, followed by a glass cover, which together creates an airtight seal. Next, the threaded end cap is tightened with a spanner wrench, and the setup is ready. FIG. 7 shows setup of the final system (Palermo, 2002).

Bulk SCF C0₂ run: CO₂ is first filtered into the chamber through the input valve. Connections to CO₂ tank are closed and lines are removed. A soap solution is used to test for leaks on connections. Band heaters are turned on to increase the temperature in the chamber, which also causes a pressure increase via the Ideal Gas Laws. The pressure generator (FIG. 7) is used to adjust pressure with the variable-volume piston along an isotherm to achieve equilibrium. Samples are exposed under the desired experimental temperature-pressure state for 60 minutes. All machines are turned off, and the chamber is quickly vented, releasing the CO₂ and leaving only the polymer tri-blend. The end cap and hot glass window are removed using tweezers. Samples were removed and stored in lab accordingly for testing. FIG. 8 (next page) is a visual summary of the process described.

DMA (Tri-tech TT- Dynamic Mechanical Analysis series 2000): Both exposed and non-exposed samples are tested for glass transition temperature (Tg) and Young's Dynamic Modulus. The DMA is used to find the modulus and Tg which will be used to calculate the composite Tg using the Flory Fox equation. The clamps and nuts from the DMA holder are removed. The samples are placed on holder, and the nuts are replaced and retightened. Tightened nuts are calibrated according to the computer-displayed level, in order to balance the sample. The cap is then put over the station and the computer run is performed. The computer program is set for a temperature run by setting time, dimensions and shape. The run is repeated for all samples, and files were labeled accordingly.

Mettler DSC thermal analysis: A Differential Scanning Calorimeter (DSC) is used to test for the Tg in the Tri-blends. First, the DSC is calibrated using its own calibration program and tools. Amounts of each sample are weighed and the correct weight is inputted into the machine. All samples are checked to see if they are properly crimped into the special metal containers made for the DSC. The tests on the DSC ranged from −25° Celsius to 180° Celsius.

Uniaxial Tension Testing (Instron 5300series): A tensile loading apparatus (commonly called by its manufacture name “Instron”) is used to test the load versus time, to determine how far the material stretches, and also to. collect stress vs. strain data. This data will later be used for strength calculations in the Izod Impact Factor equation. A demonstration of elongated polymers under tension is shown in FIGS. 9a and 9b.

### BRIEF DESCRIPTION OF THE FIGURES

The above and other objects, features and advantages of certain exemplary embodiments of the present invention will be more apparent from the following detailed description taken in conjunction with the accompanying drawings, in which:

FIG. 1 illustrates how these properties change from phase to phase;

FIG. 2 displays a graph of pressure versus temperature for CO₂, showing similar locations of the supercritical domain, with critical pressure of supercritical carbon dioxide of 73 atm and critical temperature of 31.1° C.;

FIG. 3 is the structure of PMMA Molecule;

FIG. 4 is the structure of the EVA Molecule;

FIG. 5 is the structure of the PVC Molecule;

FIG. 6 are photographs Moldings of ASTM test methods;

FIG. 7 illustrates setup of supercritical CO₂ Unit controlled by Temperature and Pressure;

FIG. 8 is a visual summary of the described process;

FIGS. 9a-9b is a photograph of Instron testing before and after break;

FIGS. 10a-10f are scanning electron microscopy images of different tri-blends;

FIG. 11 is photographs of dogbone before and after exposure;

FIG. 12 is a graphic representation of Moduli of Tri-blends;

FIGS. 13a-13b show the graphs of modulus versus Tg (red) for sample 121 before and after exposure;

FIGS. 14a-14b show the graphs of modulus versus Tg (red) for the clay sample;

FIGS. 15a-14c show graphs from DSC showing how moduli dropped after exposure; and

FIGS. 16a-16f show Instron graphs of time versus load which also is utilized in the Izod Impact Factor.

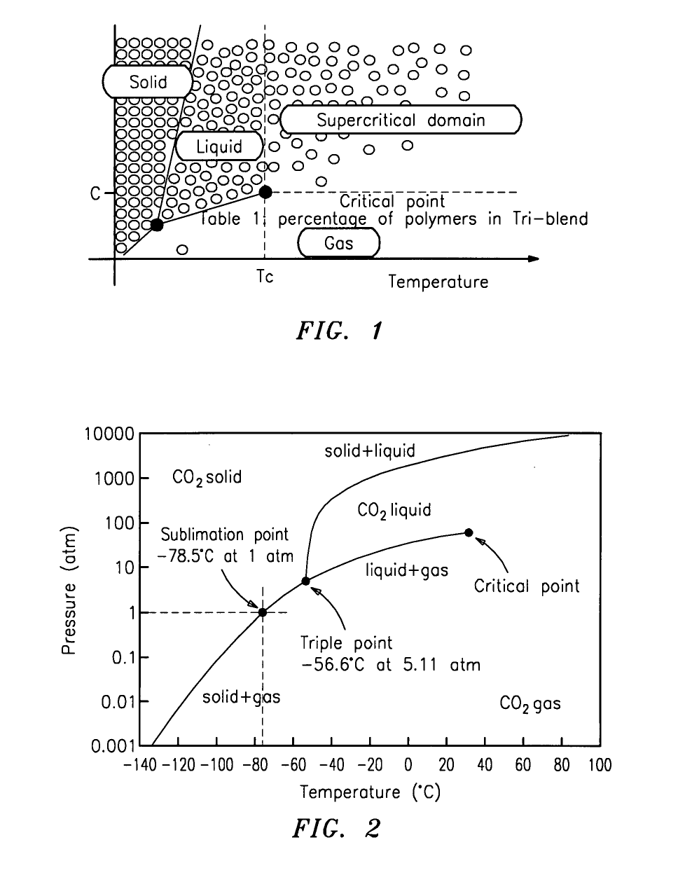

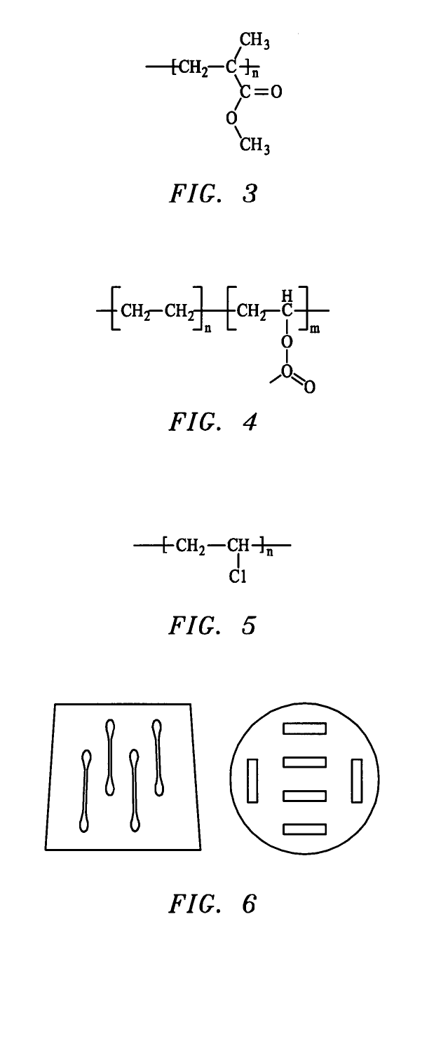

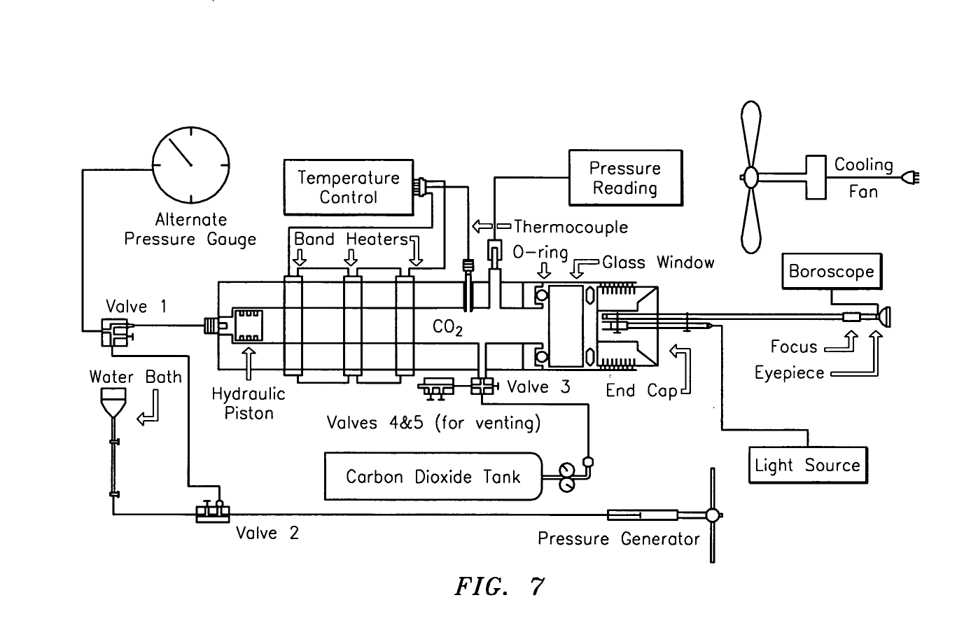

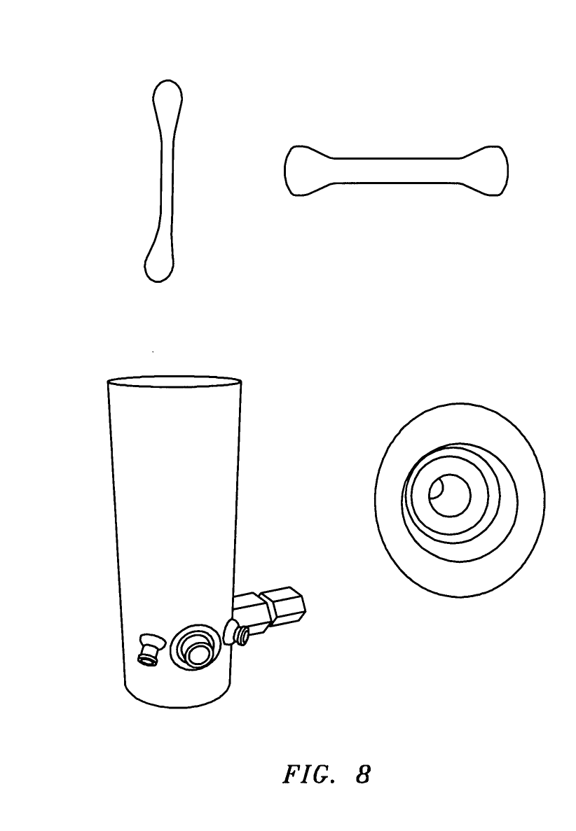

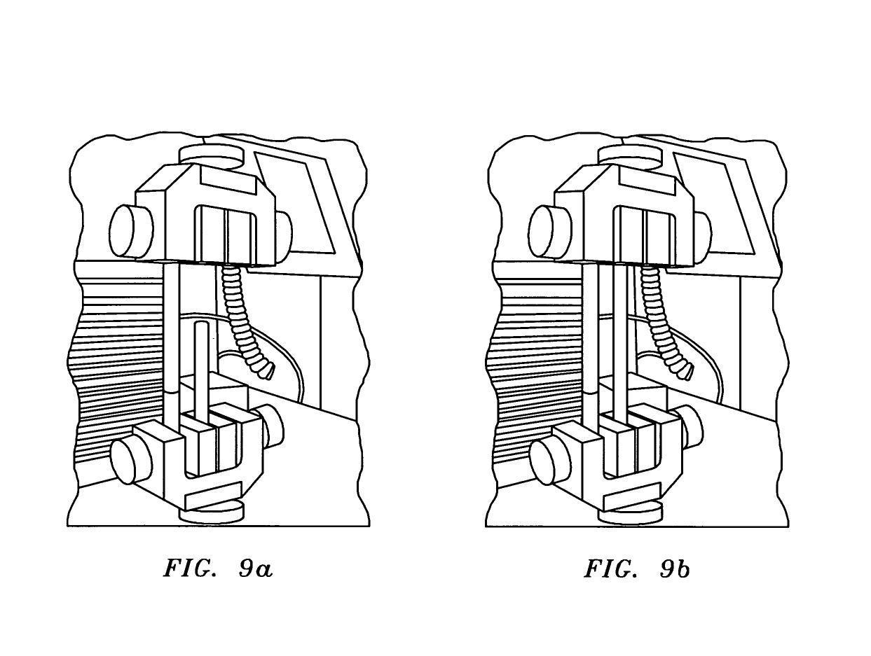

### DETAILED DESCRIPTION OF THE PREFERRED EMBODIMENTS

A description of detailed construction of preferred embodiments is provided to assist in a comprehensive understanding of exemplary embodiments of the invention. Accordingly, those of ordinary skill in the art will recognize that various changes and modifications of the embodiments described herein can be made without departing from the scope and spirit of the invention. Descriptions of well-known functions and constructions are omitted for clarity and conciseness.

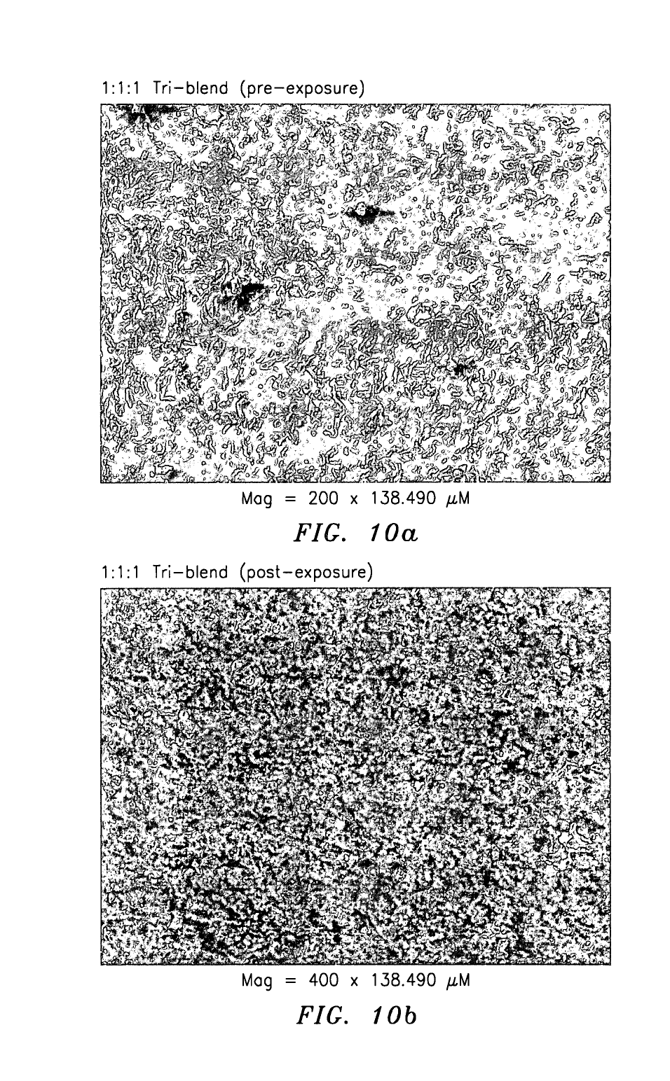

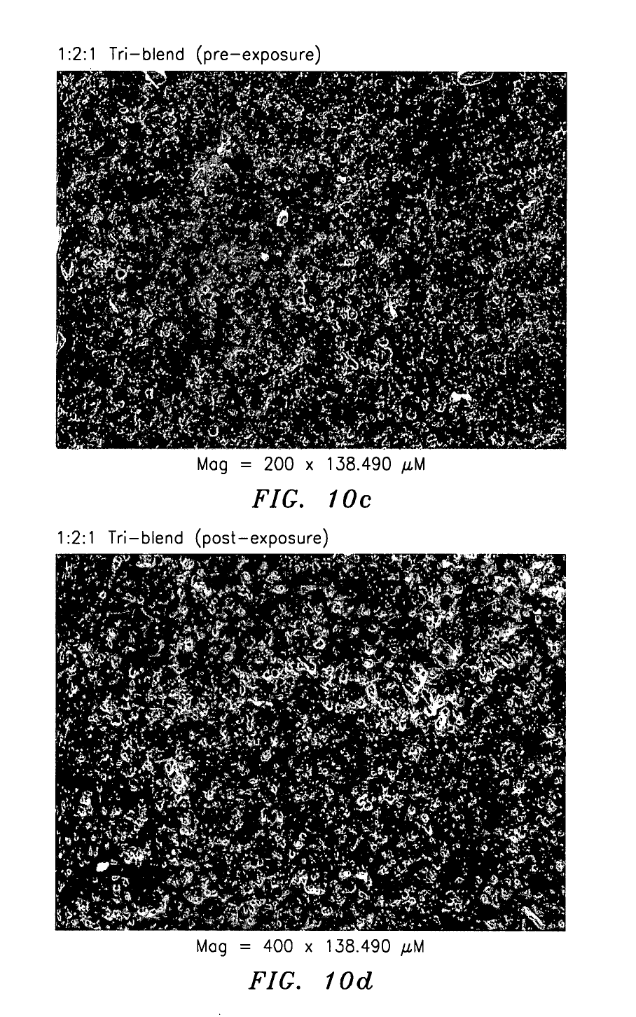

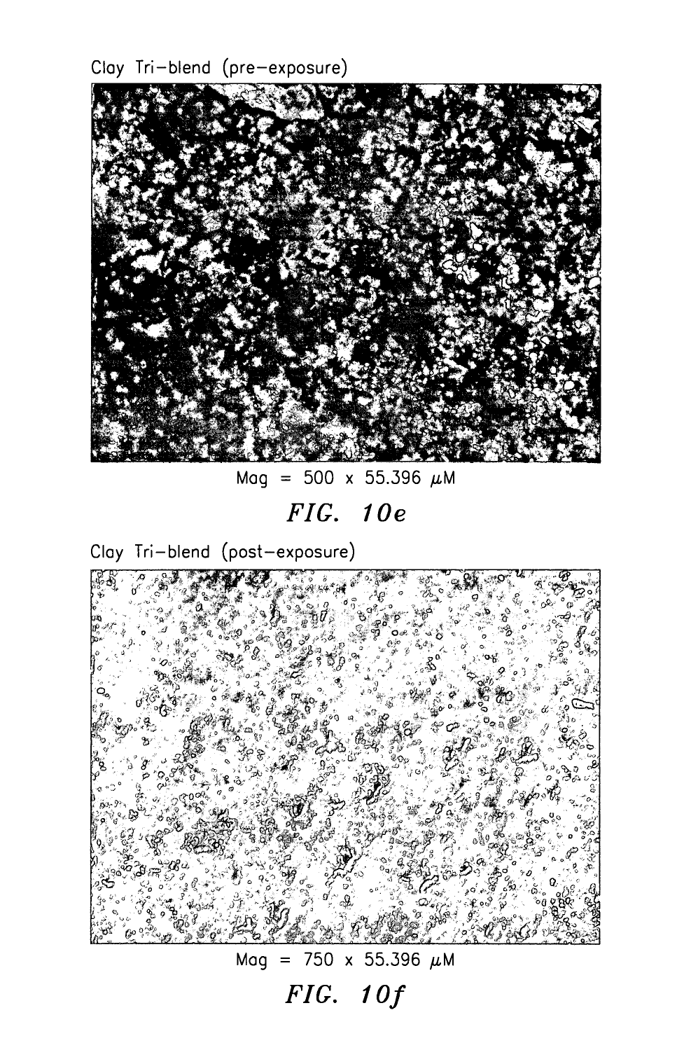

FIGS 10a-f shows the Scanning Electron Microscopy (SEM) images for the tri-blends before and after exposure to scCO₂. The post exposure SEM, (FIGS. 10a,d,f), show bubbles which indicate that the scCO₂ penetrated the surface of the blend. FIG. 11 shows the dogbone before and after exposure. After exposure, the dogbone showed a different color, size, texture which exemplifies a stronger polymer. However, these results needed to be quantified to determine the magnitude of the changes.

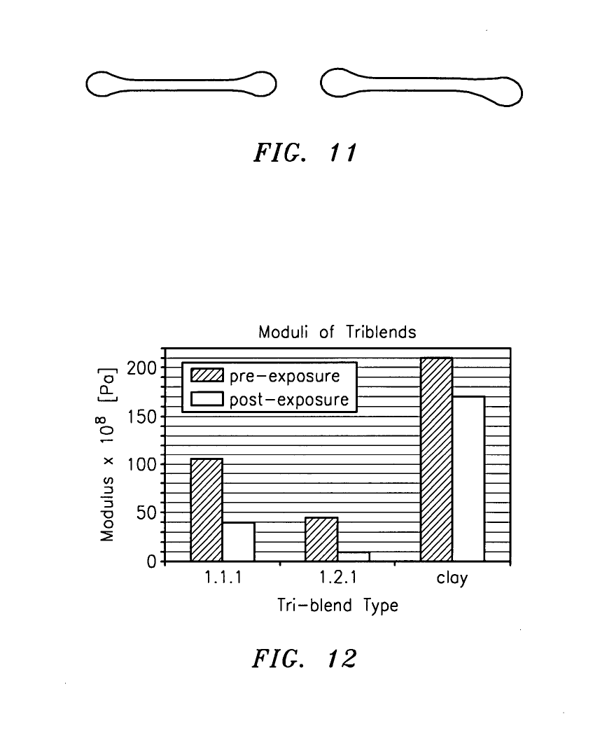

DMA: The DMA was used to test for the modulus of the materials. The results are tabulated in Table 2 (shown below) and plotted in a histogram, FIG. 12. These “tri-blends” showed reduced modulus after exposure. As the modulus decreased the material became softer and was able to be stretched farther. In the tri-blend with polymers in a 1:1:1 and 1:2:1 ratio the modulus decrease can be seen in the histogram along with the clay tri-blend modulus as well.

TABLE 2

| | ˜Modulus (PA × 10\hat{ }8) | |
|---|---|---|
| Tri- | pre- | post- |
| blends | exposure | exposure |
| 111 | 105 | 39 |
| 121 | 44 | 9.3 |
| clay | 220 | 165 |

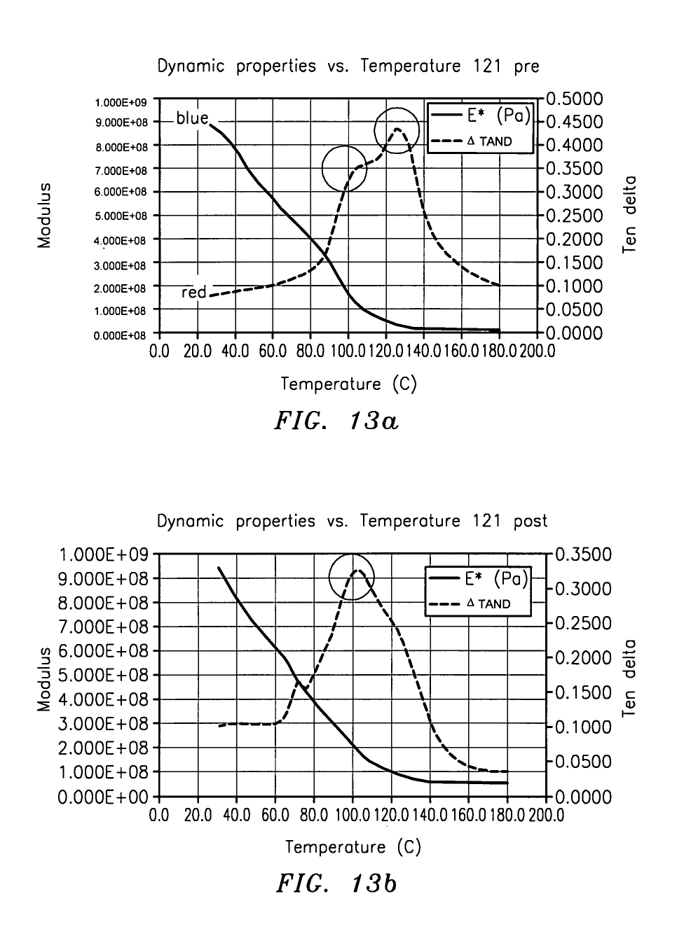

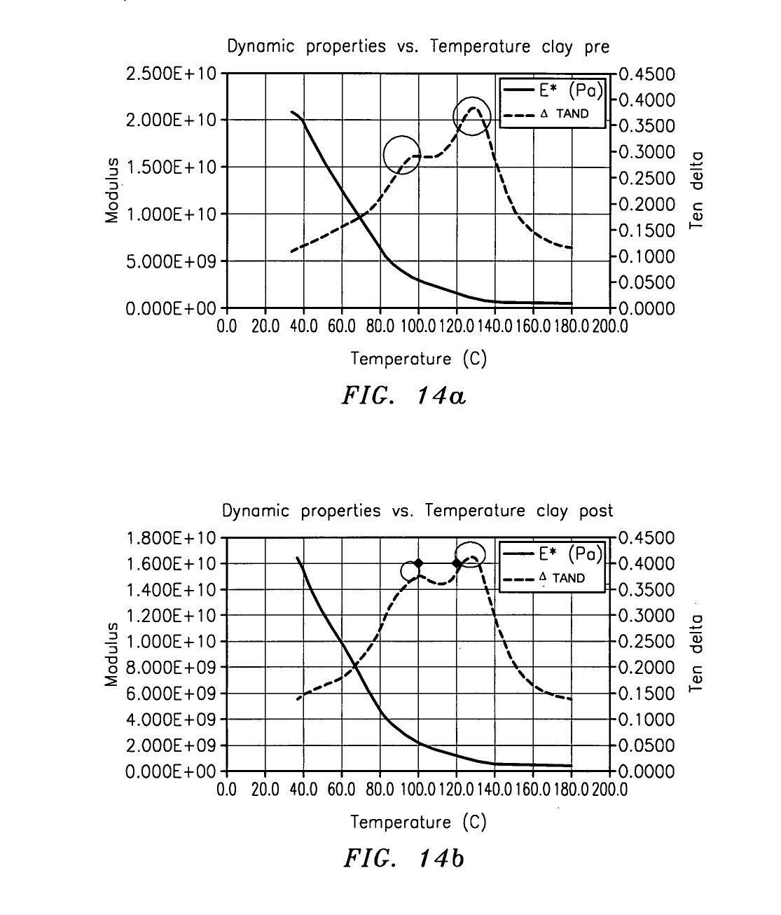

FIGS. 13a and 13b show the graphs of modulus versus Tg (red) for sample 121 before and after exposure. The DMA results reveal a merging of the relative glass transition temperatures of the polymers. Each peak on the graph represents a different polymer's Tg. Before exposure there are two peaks and after exposure these peaks merge to become one gradual peak, shown in FIGS. 13a and 13b. This signifies the compatibilization of the three or four polymers and the new Tg. The blue line for each moduli graph shows how there is no thermal breakdown even after the max temperature of 180° C. was reached. FIGS. 14a and 14b show modulus versus Tg (red) for the clay sample. The clay's Tg(s) are seen to be compatibalized by how their peaks on the modulus graph converge, although not as much as the 1:2:1 blend in FIGS. 13a and 13b.

The Flory-Fox equation (Equation 1) was used to calculate the Tg_{theory} of the polymer blend. Table 3 (shown below) shows the Tg values for Φₓ, Tgₓ, the calculated value of Tg_{4theroy} and measured value of Tg_{4blend}. Since the measured values Tg_{4blend} and theoretical value, Tg_{4theory} were within one standard deviation apart, the measured values and theoretical value correlate closely with each other. This demonstrates that the procedure followed in the study yielded good data.
φ₁T_{g1}+φ₂T_{g2}+φ₃T_{g3}=T_{g4} Equation 1
Φₓ=fraction of the of polymer out of the whole
Tgₓ=glass transition of polymer

Tg₄=final glass transition of blend

TABLE 3

| | | | | | | | | | | Tg4 | Tg4 |
|---|---|---|---|---|---|---|---|---|---|---|---|
| Tri- | | Φ1 | Φ2 | Φ3 | Φ3′ | Tg1 | Tg2 | Tg3 | Tg3′ | (blend) | (theory) |
| blend | | PMMA | EVA | PVC | clay 6A | PMMA | EVA | PVC | clay 6A | (° C.) | (° C.) |
| 111 | Pre | 0.33 | 0.33 | 0.33 | n/a | 114 | 121 | 84 | n/a | (84,112,123) = 105.8 | 106.3 |
| | Exposure | | | | | | | | | | |
| | Post | 0.33 | 0.33 | 0.33 | n/a | 114 | 121 | 84 | n/a | 107 | 106.3 |
| | Exposure | | | | | | | | | | |
| 121 | Pre | 0.25 | 0.5 | 0.25 | n/a | 114 | 121 | 84 | n/a | 104.5 114 = 109.4 | 110 |
| | Exposure | | | | | | | | | | |
| | Post | 0.25 | 0.5 | 0.25 | n/a | 114 | 121 | 84 | n/a | 109.5 | 110 |
| | Exposure | | | | | | | | | | |
| Clay | Pre | 0.23 | 0.46 | 0.23 | 0.08 | 114 | 121 | 84 | 78 | 94 126 = 110 | 109 |
| | Exposure | | | | | | | | | | |
| | Post | 0.23 | 0.46 | 0.23 | 0.08 | 114 | 121 | 84 | 78 | 98.5 122.5 = 110.5 | 109 |
| | Exposure | | | | | | | | | | |

DSC:

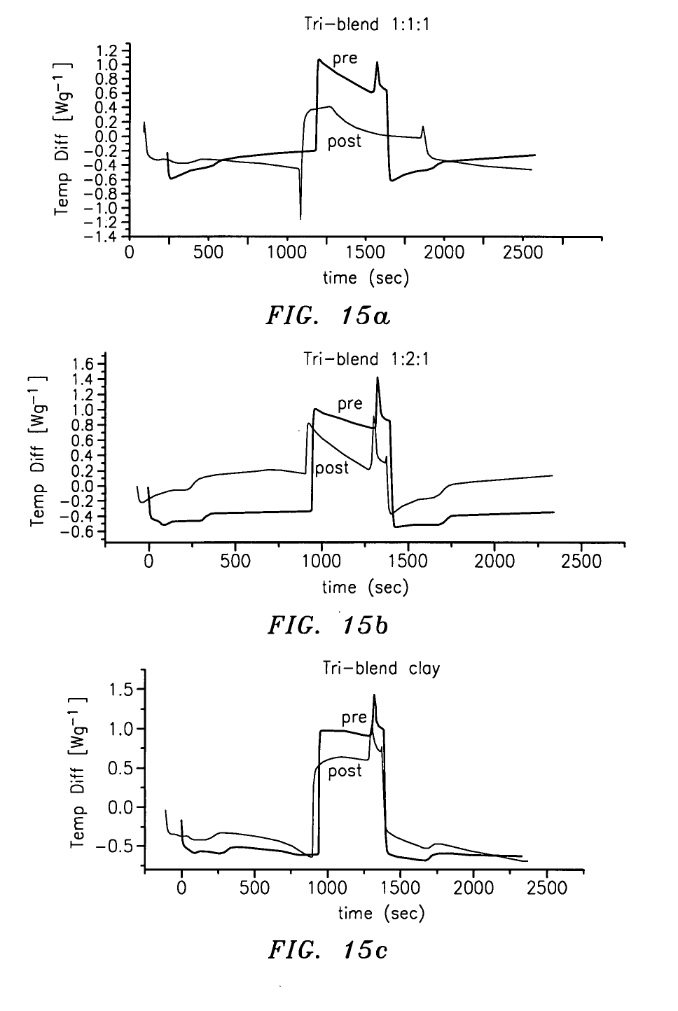

The results from the DSC verify the decrease in modulus observed by DMA. The modulus of the pre-exposed samples was higher than that of its post exposed companion. FIGS. 15a-c show the graph of temperature differential [Wgˆ-1] or modulus versus time for the three blends before and after exposure. Tri-blends with ratios of 1:1:1 and 1:2:1 both showed a highly noticeable decrease in modulus. This shown by the decreasing peaks of the “pre”-exposure and “post”-exposure graphs, FIGS. 15a and 15b. These changes are statistically greater than the clay tri-blend's decrease. This can be explained by the fact that clay has been shown to compatibalize polymers in the blend even before exposure. However, supercritical Carbon Dioxide was able to further decrease the blend's modulus, as shown in FIG. 15c.

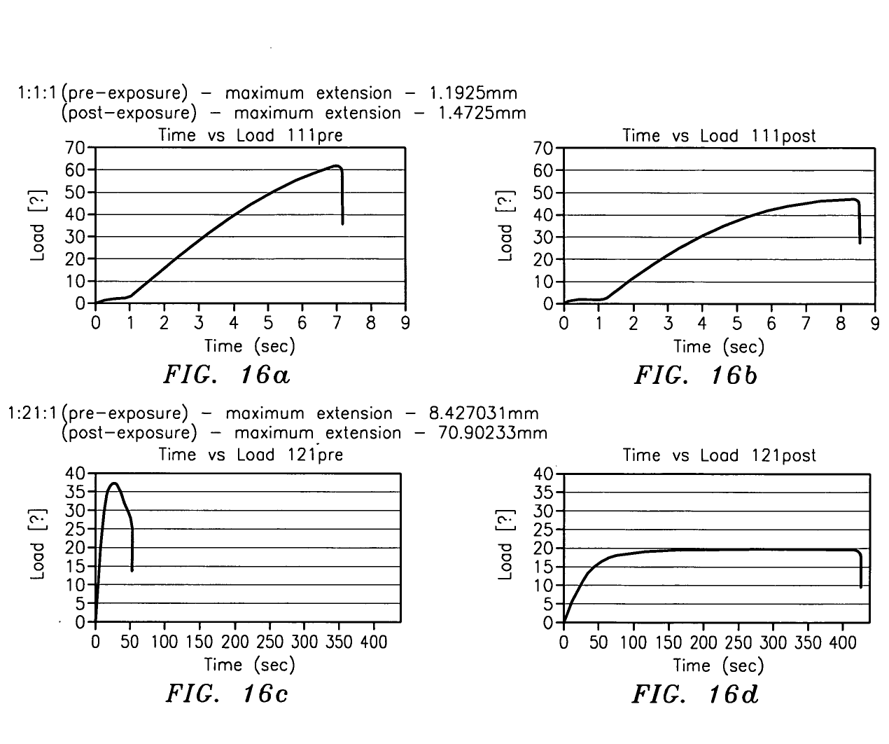

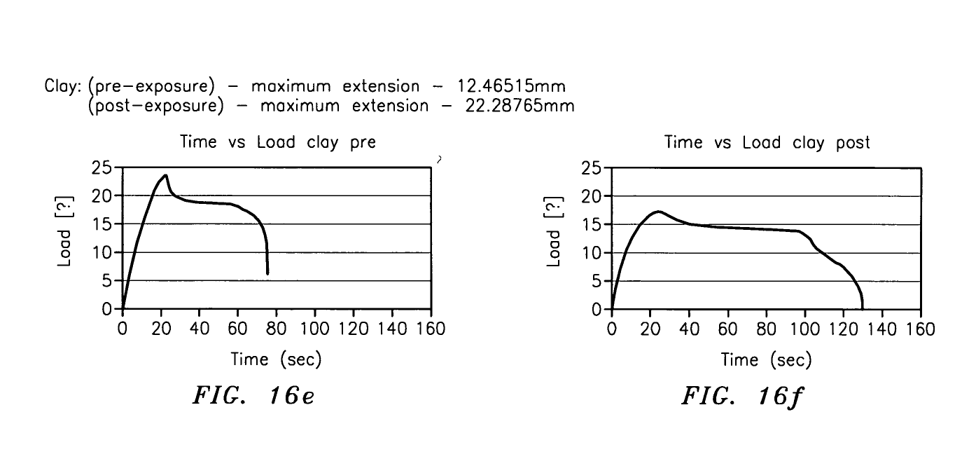

Instron: Results graphed by the Instron (FIGS. 16a-f) display load versus time for all Tri-blends and how these blends became a stronger material after exposure. Equation 2 shows the Izod Impact Factor, which measures the amount of stored energy. Stored energy is directly proportional to strength. The larger the Izod Impact Factor the stronger and tougher the material. The results are tabulated in Table 4 (Shown below), showing the increased strength of the material after exposure. For the 1:2:1 blend, the Izod Impact factor increased more than seven fold.

TABLE 4

| | Izod Impact Factor | |
|---|---|---|
| Tri- | pre- | post |
| blends | exposure | exposure |
| 111 | 180 | 197.5 |
| 121 | 1200 | 8600 |
| clay | 1220 | 1625 |

This project created three tri-blend plastics from recycled PVC. Exposure to supercritical CO₂ exposure has definite effects on the mechanical properties of recycled polymers in blends with other virgin polymers. DMA confirms that distinct component points converge to a singular observable Tg after blends are exposed to scCO₂. Each of these blends showed different mechanical changes (modulus, Tg, compatibility), pre and post exposure. The 1:2:1 ratio polymer having greater positive changes than the clay blend and 1:1:1 post exposure. The Izod impact factor showed an increase in strength after exposure. The application of the Flory-fox equation showed a close correlation between predicted and measured Tg. Visual examination showed CO₂ penetration of the surface on the tri-blends. Finally, it was discovered that scCO₂ can be a positive compatibalizer of PVC blend, leading to desirable mechanical properties.

While this invention has been particularly shown and described with reference to preferred embodiments thereof, it will be understood by those skilled in the art that various changes in form and details may be made therein without departing from the scope of the invention encompassed by the appended claims.

What is claimed is:

1. A method for producing supercritical carbon dioxide treated blends comprising the steps of:
(i) blending at least three compatible materials in a melt intercalation to produce a tri-blend;
(ii) molding said tri-blend of step (i) into shapes suitable for ASTM; and
(iii) exposing said tri-blend mixture to C0₂ for a predetermined amount of time so as to produce a supercritical carbon dioxide treated tri-blend material.

2. A supercritical carbon dioxide treated blend comprising:
a blend of at least three compatible meltable materials treated with supercritical carbon dioxide for a defined period of time.
